(19) United States
(12) Patent Application Publication
(10) Pub. No.: US 2025/0384271 A1
(43) Pub. Date: Dec. 18, 2025

(54) PARAMETER-EFFICIENT NEURAL NETWORK MODEL ADAPTATION AND INFERENCE VIA MATRIX SHARING

(71) Applicant: Adobe Inc., San Jose, CA (US)

(72) Inventors: Zhao SONG, Redmond, WA (US); Ritwik Sinha, Cupertino, CA (US); Raghavendra Kiran Addanki, Santa Clara, CA (US); Lichen Zhang, Cambridge, MA (US)

(21) Appl. No.: 18/740,772

(22) Filed: Jun. 12, 2024

(51) Int. Cl. G06N 3/082

(52) U.S. Cl. CPC G06N 3/082

(57) ABSTRACT

Some aspects relate to technologies for neural network model adaptation and inference for multiple tasks via matrix sharing. In accordance with some aspects, a neural network model is accessed that has a pre-trained matrix at a layer of the neural network model. A shared matrix and a task matrix are added to the pre-trained matrix at the layer of the neural network model. The neural network model is trained for a plurality of tasks by updating the task matrix for each task to provide a trained task matrix for each task while maintaining the pre-trained matrix and the shared matrix the same for all tasks.

### BACKGROUND

Neural network models, such as large language models (LLM), have become important tools for many machine learning research and applications. Due to large parameter count and an enormous amount of training data, some neural network models are strong at general tasks. For most applications, however, a smaller, more parameter-efficient neural network model specialized in a particular field may be desired. This motivates the design of model adaption, such as fine-tuning processes that tune a pre-trained neural network model for a number of iterations on a dedicated dataset for specific tasks. If not handled correctly, the fine-tuning process creates another neural network model that has a comparable amount of parameters, significantly slowing down any downstream applications.

### SUMMARY

Some aspects of the present technology relate to, among other things, neural network model adaptation and inference via matrix sharing across multiple tasks. In accordance with some aspects, a pre-trained neural network model is accessed that has one or more layers that each has a pre-trained matrix. Each pre-trained matrix is supplemented with two matrices—a shared matrix and a task matrix—to provide a supplemented layer comprising the pre-trained matrix, the shared matrix, and the task matrix. Parameters of the pre-trained matrix and the shared matrix at each supplemented layer are frozen. The neural network model is then trained on task-specific training data for each of a number of different tasks by updating the task matrix to provide a trained task matrix at each supplemented layer for each task. The trained task matrices are stored in a data store as matrix data for use during model inference.

For model inference, input data is received for a task. A task type for the input is determined, and a trained task matrix for each supplemented layer is retrieved based on the task type. The task is performed on the input data using the neural network model with each supplemented layer using a pre-trained matrix, a shared matrix, and a trained task matrix retrieved based on the task type.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example of a pre-trained matrix, shared matrix, and task-specific matrices at a layer of a neural network model in accordance with some implementations of the present disclosure;

FIG. 3 is a flow diagram showing a method for model adaptation in accordance with some implementations of the present disclosure;

FIG. 4 is a flow diagram showing a method for model inference in accordance with some implementations of the present disclosure; and

FIG. 5 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “neural network model” (or “model”) refers to an artificial neural network that comprises multiple operational layers. In some aspects, a neural network model can include an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a neural network model to produce a correct output.

A “weight matrix” refers a set (i.e., a matrix) of parameters (i.e., weights) for a layer of a neural network model. Each weight in a weight matrix determines the strength of the connection between a pair of neurons in adjacent layers. A neural network model can have a number of layers, each with its own weight matrix, although some layers may not use a weight matrix.

A “pre-trained matrix” refers to a set of weights for a layer in a neural network model that has been previously trained on a dataset. For example, a neural network model could be trained on a dataset for natural language processing in which the weights of a weight matrix for a layer of the neural network model are updated during the training process to provide a pre-trained matrix.

As used herein, a “shared matrix” refers to a first matrix added to a pre-trained matrix in which the parameters are maintained during model adaptation for different tasks such that the parameters of the shared matrix are the same for the different tasks.

A “task matrix” refers to a second matrix added to a pre-trained matrix in which the parameters are updated during model adaptation for different tasks such that the parameters of the task matrix are task-specific for each task. A “trained task matrix” refers to a task matrix whose parameters have been updated for a particular task using training data specific to that task.

A “supplemented layer” is used herein to refer to a layer of a neural network model in which a pre-trained matrix in the layer has been supplemented with a shared matrix and a task matrix.

As used herein, a “supplemented neural network model” refers to a neural network model having at least one supplemented layer.

### Overview

Neural network models, including large language models (LLMs) such as GPT-4, are becoming increasingly important in the realm of artificial intelligence and information technology, serving a multitude of functions across various sectors. For instance, the ability of LLMs to understand, generate, and interact with human language in a nuanced manner makes them useful tools in everything from customer service and data analysis to content creation and decision support systems. Beyond automating tasks, LLMs contribute to the development of conversational agents that can assist with mental health, offer educational tutoring, and provide specialized advice in legal or medical fields, to name a few applications. Neural network models can process and analyze vast amounts of data far more quickly than humans, making them particularly useful in sifting through large datasets to identify trends or insights. Thus, neural network models are not only reshaping humans interaction with technology but also have the potential to significantly impact how to solve complex problems, improve efficiency, and enhance the quality of life.

Model adaptation, such as fine-tuning, is often performed to harness the full potential of neural network models, tailoring their generalized capabilities to meet specific needs or goals. While some neural network models are trained on a broad range of data to perform various tasks, they often require further customization to excel in specialized applications. Fine-tuning allows, for instance, businesses, researchers, and developers to adapt neural network models for particular industries, such as, for instance, healthcare, finance, or law, thereby optimizing their performance and making them more effective and reliable tools. Often, this customization not only improves the model's utility but also helps in mitigating biases, ensuring ethical use, and meeting compliance standards. In essence, model adaptation is the bridge between a model's generalized abilities and its application in solving real-world, domain-specific problems, making it an important element in the deployment of neural network models across diverse settings. Moreover, model adaptation is important for commercial deployment of neural network models, with the goal of providing a simple, lightweight, and efficient approach to perform fast inference for dedicated tasks.

Conventionally, the process of model adaptation for a neural network model involves several methods, each with its unique advantages, depending on the application and goals. One common approach is data augmentation, where the existing dataset is expanded by adding variations of the data to increase diversity and reduce overfitting. Another method is curriculum learning, which involves progressively training the model on increasingly complex tasks, allowing it to build up its expertise gradually. Transfer learning is also widely used, taking a pre-trained model and adapting it for a specific task by training it further on a specialized dataset. Feature-based fine-tuning involves extracting certain layers or “features” from the pre-trained model and incorporating them into a new model designed for the specific task. Hyperparameter tuning, where settings like learning rate or batch size are adjusted, is also used for optimizing performance. Additionally, multi-task learning can be employed to fine-tune the model on several related tasks simultaneously, thereby enhancing its generalizability. These methods can be used individually or in combination to ensure that the model performs optimally in its designated role, making fine-tuning a versatile and important step in the deployment of neural network models.

One technical challenge of model adaptation is addressing the parameter count. Let W₀∈ [symbol] denote the pre-training model weight; note that if done naively, even fine-tuning on a single data point will end up with a model as large as W₀, as the ΔW∈ [symbol] is without any structure if no further assumptions are imposed. In other words, if fine-tuning is done naively, the number of parameters in the fine-tuned model can be as large as the original neural network model even if the training dataset is very small. This makes both the fine-tuning and inference processes slow. On the other hand, fine-tuning should be parameter-efficient and highly structured, as most of the technical heavy lifting has been handled by the time- and parameter-consuming pre-trained model W₀.

To provide a concrete example, consider fine-tuning an LLM for a wide range of five tasks: sentiment analysis, question-answering, detecting duplicate questions, detecting grammar errors and textual entailment. Fine-tuning these tasks on GPT3 naively would result in a total of 0.85 billion parameters. This is too many parameters for any application, and the total size of dataset (combining all fine-tune tasks) is <1 million, so the size of dataset is much smaller than the total number of parameters. Fine-tuning these tasks and later deploying them for inference would be costly.

Drawing inspiration from deep learning theory, where the gradients of model weights are usually low-rank due to over-parametrization, one current work presented the Low-Rank Adaptation (LoRA) framework, where it is assumed the fine-tuning weights ΔW admit a rank-r factorization for a hyperparameter r. During training, LoRA freezes the pre-trained weights and adds two trainable rank matrices (A and B) or rank r to each layer. While d and m can be as large as 10⁴ to 10⁵ and lead to a pre-trained model with trillions of parameters, the LoRA approach allows one to pick r=50 or 100, reducing the parameter count by more than 100× fold. Moreover, by performing the fine-tuning process on a low-rank model ΔW=AB for A∈ [symbol] and B∈ [symbol] , the LoRA approach also effectively improves the inference time, as multiplying a vector with ΔW can be performed by first multiplying with matrix B and then computing the matrix-vector product using matrix A and the resulting vector, providing a runtime improvement from O(md) to O(mr+dr). Due to these advantages, LoRA has become a building block for the fine-tuning procedure of many LLMs, including GPT-3.

Despite its impressive empirical performance, LoRA does have several drawbacks. The method itself is still a heuristic, as the work does not provide convergence guarantees and they instead motivate the effectiveness of LoRA from the perspective of subspace similarity. From an algorithmic perspective, LoRA requires each individual fine-tuning task to learn a distinct pair of low-rank matrices Aᵢ, Bᵢ. This ignores the potential relevance between different tasks that can be fine-tuned on the same neural network model.

Aspects of the technology described herein improve the functioning of the computer itself in light of these shortcomings in existing technologies by providing a framework for parameter-efficient model adaption via matrix sharing across multiple tasks. As noted above, given k fine-tuning tasks, the prior LoRA framework maintains low-rank matrices Aᵢ, Bᵢ for each task. In contrast, the technology described herein provides a framework that uses a single, shared matrix A across all k tasks (referred to herein as a shared matrix), while fine-tuning matrix Bᵢ for each task (referred to herein as task matrices). This reduces the number of parameters by almost half. Moreover, each fine-tuning iteration is even more efficient as the training process optimizes over only the matrix Bᵢ.

In accordance with some aspects of the technology described herein, a neural network model is accessed that has one or more layers with a pre-trained matrix. The pre-trained matrix at each layer is supplemented with a shared matrix and a task matrix, thereby providing a supplemented neural network model having one or more supplemented layers that include a pre-trained matrix, a shared matrix, and a task matrix. The parameters of the pre-trained matrix and the shared matrix at each supplemented layer are frozen. The supplemented neural network model is then trained for k tasks. In some aspects, this includes training the model on task-specific training data for each of the k tasks to update the task matrix at each supplemented layer for each task, thereby providing k task matrices for each supplemented layer. The task matrices are stored for use during inference.

When input for a task is received for processing by a neural network model trained in accordance with aspects described herein, a task type is determined. Based on that task type, a task matrix for each supplemented layer of the neural network model is accessed. The task is then performed by processing the input using the neural network model, in which each supplemented layer includes a pre-trained matrix, shared matrix, and task matrix retrieved based on the task type for the task being performed.

Aspects of the technology described herein provide a number of improvements over existing technologies. For instance, the technology described herein provides a solution that is more parameter efficient than the state of the art LoRA approach. For instance, suppose there are k fine-tune tasks, the LoRA solution would require learning 2k different low-rank factors, while the approach of the technology described herein only needs to learn k+1 different low-rank factors. As k grows larger, the present technology saves almost 50% of parameters compared to LoRA. The technology described herein is more time efficient in terms of fine-tuning. Each iteration only needs to train a single matrix instead of two matrices compared to LoRA, thereby shaving the time for backpropagation by almost 50%. The technology described herein enables a single low-rank module to be shared across different tasks, meaning they can leverage information and shared structure across different fine-tuning datasets. Experiments have demonstrated that the technology described herein provides similar performance as LoRA while using only about 60% of parameters compared to LoRA.

### Example System for Neural Network Model Adaptation and Inference Via Matrix Sharing

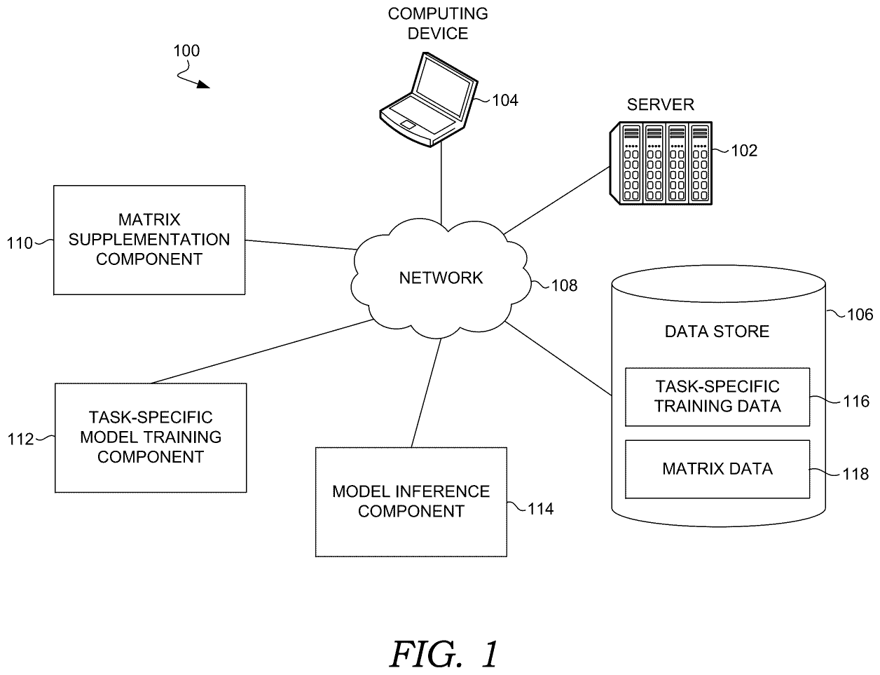

With reference now to FIG. 1, an example operating environment 100 in which aspects of the technology can be employed is provided. Among other device, components, modules, or engines not shown, operating environment 100 comprises a server 102, a computing device 104, a data store 106, a matrix supplementation component 110, a task-specific model training component 112, and a model inference component 114, which are communicating via network 108.

It is noted and again emphasized that any additional or fewer components, in any arrangement, can be employed to achieve the desired functionality within the scope of the present disclosure. Although the various components of FIG. 1 are shown with lines for the sake of clarity, in reality, delineating various components is not so clear, and metaphorically, the lines can more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements can be omitted altogether.

Further, some of the elements described in relation to FIG. 1, such as those described in relation to the matrix supplementation component 110, the task-specific model training component 112, and the model inference component 114, are functional entities that can be implemented as discrete or distributed components or in conjunction with other components, and in any suitable combination and location. Various functions described herein are being performed by one or more entities and can be carried out by hardware, firmware, or software. For instance, various functions can be carried out by a processor executing computer-executable instructions stored in memory. Moreover, functions of the matrix supplementation component 110, the task-specific model training component 112, and the model inference component 114, among other functions, can be performed by the server 102, the computing device 104, or any other component, in any combination.

The data store 106 generally stores information, including data, computer instructions (e.g., software program instructions, routines, or services), or models used in embodiments of the described technologies. For instance, the data store 106 can store computer instructions for implementing any of the matrix supplementation component 110, the task-specific model training component 112, and the model inference component 114. Although depicted as a single data store component, the data store 106 can be embodied as one or more data stores or can be in the cloud.

The network 108 can include one or more networks (e.g., public network or virtual private network [VPN]). The network 108 can include, without limitation, one or more local area networks (LANs), wide area networks (WANs), or any other communication network or method.

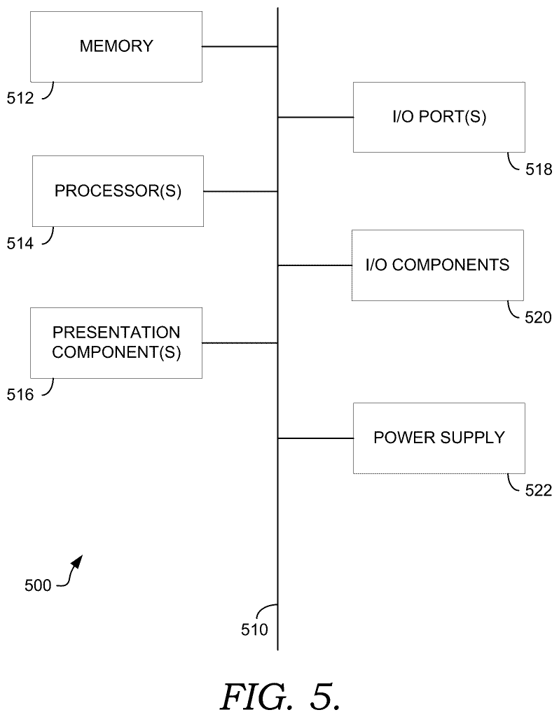

Generally, the server 102 is a computing device that implements functional aspects of operating environment 100, such as one or more functions of the matrix supplementation component 110, the task-specific model training component 112, and the model inference component 114. One suitable example of a computing device that can be employed as the server 102 is described as computing device 500 with respect to FIG. 5. In implementations, the server 102 represents a back-end or server-side device.

The computing device 104 is generally a computing device that can be employed as a client-side or front-end device. As with other components of FIG. 1, the computing device 104 is intended to represent one or more computing devices. One suitable example of a computing device that can be employed as computing device 104 is described as computing device 500 with respect to FIG. 5. In addition to the server 102, the computing device 104 can also implement functional aspects of operating environment 100, such as one or more functions of the matrix supplementation component 110, the task-specific model training component 112, and the model inference component 114. It will be understood that some implementations of the technology will comprise either a client-side or front-end computing device, a back-end or server-side computing device, or both, executing any combination of functions from the matrix supplementation component 110, the task-specific model training component 112, and the model inference component 114, among other functions.

The matrix supplementation component 110 and the task-specific model training component 112 collectively provide model adaptation (e.g., fine-tuning) for a pre-trained neural network model. The pre-trained neural network model has a pre-trained matrix for at least one layer. The matrix supplementation component 110 adds a shared matrix and a task matrix (which can comprise low-rank matrices) to the pre-trained matrix. In some instances, the pre-trained neural network model can have a different pre-trained matrix at multiple layers, and the matrix supplementation component 110 adds a shared matrix and a task matrix to the pre-trained matrix at each layer. In some aspects, the pre-trained neural network can have one or more layers without a pre-trained matrix, and the matrix supplementation component 110 does not supplement those layers. In some further aspects, one or more layers of the neural network model with a pre-trained matrix are not supplemented with a shared matrix and a task matrix. Layers of a neural network model that have a pre-trained matrix and have been supplemented with a shared matrix and a task matrix are referred to herein as supplemented layers. Additionally, a pre-trained neural network model with at least one supplemented layer is referred to herein as a supplemented neural network model.

In some aspects, parameters of the shared matrix at each supplemented layer are initialized with random Gaussian values. Additionally, in some aspects, parameters of the task matrix at each supplemented layer are initialized with zero values. However, parameters of each shared matrix and parameters of each task matrix can be initialized with different values in accordance with aspects of the present technology.

The task-specific model training component 112 adapts (e.g., fine-tunes) a supplemented neural network model for a number of different tasks using task-specific training data 116 from the data store 106. In particular, the task-specific model training component 112 trains the supplemented neural network model by updating the task matrix at each supplemented layer using task-specific training data 116 for each task to provide a trained task matrix at each supplemented layer for each task while maintaining the pre-trained matrix and the shared matrix at each supplemented layer the same for all tasks.

In some aspects, the task-specific model training component 112 freezes the parameters of the pre-trained matrix and the parameters of the shared matrix at each supplemented layer. For each task, the task-specific model training component 112 accesses task-specific training data 116 from the data store 106, and trains the supplemented neural network model by updating the parameters of the task matrix at each supplemented layer based on the task-specific training data 116. For instance, the task-specific training data 116 could include a first set of training data for a first task (e.g., sentiment analysis), a second set of training data for a second task (e.g., question-answering), a third set of training data for a third task (e.g., detecting duplicate questions), a fourth set of training data for a fourth task (e.g., detecting grammar errors), and a fifth set of training data for a fifth task (e.g., textual entailment). In that case, the task-specific model training component 112 trains the supplemented neural network model for the first task on the first set of training data, trains the supplemented neural network model for the second task on the second set of training data, trains the supplemented neural network model for the third task on the third set of training data, trains the supplemented neural network model for the fourth task on the fourth set of training data, and trains the supplemented neural network model for the fifth task on the fifth set of training data.

As a result of the training, at each supplemented layer, a different trained task matrix is provided for each task while the pre-trained matrix and the shared matrix are the same across the tasks. Continuing the example above with five tasks, for a first supplemented layer, a first trained task matrix would be provided for the first task, a second trained task matrix would be provided for the second task, a third trained task matrix would be provided for the third task, a fourth trained task matrix would be provided for the fourth task, and a fifth trained task matrix would be provided for the first task. However, the pre-trained matrix and the shared matrix at that first supplemented layer would be the same for the five tasks. The trained tasks matrix at each supplemented layer for each task is stored as matrix data 118 in the data store 106. As such, the trained matrix data can be retrieved from the data store 106 for model inference to perform tasks on input data.

Algorithm 1 provided below illustrates an example operation of neural network model adaptation for k tasks in accordance with some aspects of the technology described herein. In algorithm 1, A refers to a shared matrix and B refers to a task matrix.

Algorithm 1 Parameter reduction through sharing a low-rank module across all fine-tuning
tasks. W₀ is used to denote the pre-trained model weights (i.e., pre-trained matrix), r to
denote the rank parameter of low-rank modules, L to denote the loss function that takes in a
pre-trained weight, a low-rank factorization of fine-tuning weight and an m-dimensional data
point. k denotes the total number of tasks to be fine-tuned, and X₁, . . . , Xₖ denote specific
datasets for each task. Finally, let T denote the total number of fine-tuning episodes.

| | |
|---|---|
| 1: | Procedure (W₀ ∈ [symbol] ^{d×m}, r, L: [symbol] ^{d×m} × [symbol] ^{d×r} × [symbol] ^{r×m} × [symbol] ^{m} → [symbol] , k, X₁, ∈ [symbol] ^{m×n}^{₁}, . . . , Xₖ ∈ [symbol] ^{m×n}^{ₖ}, T) |
| 2: | /* Initialization stage: initialize A(0) with random Gaussian and Bᵢ(0) to 0_{r×m} · */ |
| 3: | Initialize each entry of A(0) as independent [symbol] (0,1) |
| 4: | for i = l → k do |
| 5: | Bᵢ(0) ← 0_{r×m} |
| 6: | end for |
| 7: | /* Fine-tuning stage: freeze W₀ and A(0), while tuning for each Bᵢ(t) · */ |
| 8: | for t = l → T do |
| 9: | A(t) ← A(t − 1) [symbol] Freeze shared module A. |
| 10: | for i = l → k do |
| 11: | Update Bᵢ(t) using Bᵢ(t − 1) and ∇_{B}L(W₀, A(t), Bᵢ(t − 1), Xᵢ) |
| 12: | end for |
| 13: | end for |
| 14: | return A(T), ${\{ {B}_{i} ( T ) \}}_{i = 1}^{k}$ |
| 15 | end procedure |

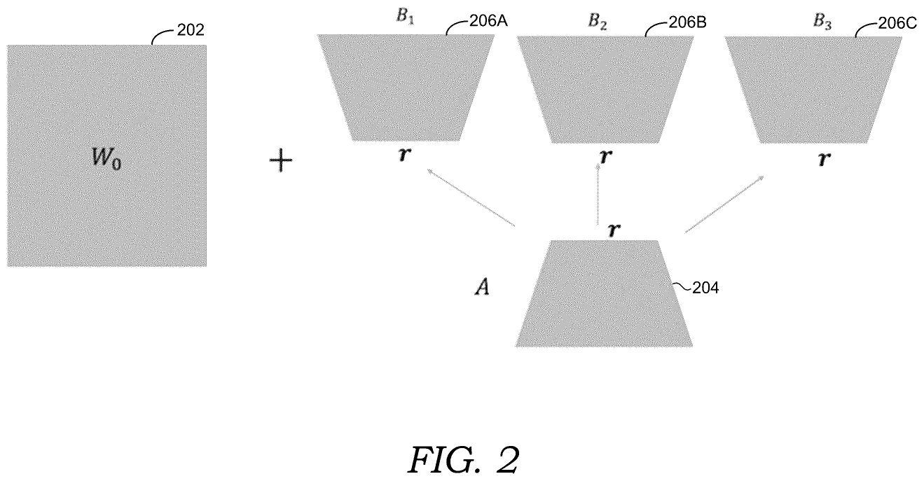

FIG. 2 is a block diagram showing an example of a layer of a neural network model trained in accordance with some aspects of the technology described herein. In the present example, the neural network model has been trained for three tasks. As shown in FIG. 2, the layer includes a pre-trained matrix 202 and a shared matrix 204 that are the same for all three tasks. Three different task matrices 206A-C are also shown. Each of the task matrices 206A-C has been trained on a different set of training data for each task. While FIG. 2 provides an example in which the layer of the neural network model has been trained for three tasks, it should be understood that a layer of a neural network model can be trained for any number of tasks.

With reference again to FIG. 1, the model inference component 114 performs tasks using a neural network model trained in accordance with aspects of the technology described herein. Given input for a task to be performed using a neural network model, the model inference component 114 determines a task type for the task. Based on the determined task type, the model inference component 114 accesses, from the matrix data 118 of the data store 106, the trained task matrix for each supplemented layer of the neural network model. The model inference component 114 performs the task on the input using the neural network model with the trained task matrix for each supplemented layer. In particular, the task is performed with each supplemented layer of the neural network model having a pre-trained matrix, a shared matrix, and a trained task matrix.

In some aspects, the model inference component 114 receives input for multiple tasks and performs the tasks sequentially. For instance, the model inference component 114 could perform a first task using trained task matrices for the first task followed by a second task using trained task matrices for the second task. In such instances, the model inference component 114 can perform the second task after performing the first task by subtracting the trained task matrix for the first task from each supplemented layer to obtain the pre-trained matrix and the shared matrix at each supplemented layer and adding the trained task matrix for the second task at each supplemented layer.

The following discussion provides a mathematical model for the technology described herein from the perspective of loss functions. Specifically, it is shown that by the formulation of global loss discussed herein, the local structure can be propagated to global.

Initially, the formulation of the loss is set forth as follows:
Definition 1.1 (A mathematical interpretation of the model). Let L: [symbol] × [symbol] → [symbol] denote a loss function. Let k≥1 denote a positive integer. Define the global loss function [symbol] : [symbol] × [symbol] → [symbol] as follows

$$ℒ ( x , y ) : = {\sum }_{i = 1}^{k} L ( x , {y}_{i} )$$

where y∈ [symbol] is a vector that concatenates all k parameters for each

$${y}_{i} \text{:} y := {[ \begin{matrix}{y}_{1}^{T} & {y}_{2}^{T} & … & {y}_{k}^{T}\end{matrix} ]}^{T}$$

Lemma 1.2 (Informal of Lemma 2.4, lipschitz). If L is γ-Lipschitz, then [symbol] is (γκ)-Lipschitz.
Lemma 1.3 (Informal of Lemma 2.6, smoothness). If L is β-smooth, then [symbol] is (kβ)-smooth.

The results for Lipschitzness and smoothness don't require additional assumptions. However, for strong convexity, extra structural assumptions are needed (for details see Lemma 2.8 below) as otherwise counterexample exists.
Lemma 1.4 (Informal of Lemma 2.8, strongly convex). If L is α-strongly convex and under certain assumptions, then [symbol] is (0.5α)-strongly convex.

Consequentially, standard first-order optimization methods can be applied directly to the approach described herein and convergence can be obtained.
NOTATIONS: In the following, [n] is used for a positive integer n to denote the set {1, 2, . . . , n}. Given a vector x, ∥x∥₂, is used to denote its [symbol] norm. Given a matrix A, ∥A∥ is used to denote its spectral norm and ∥A∥ₚ to denote its Frobenious norm. Given a matrix A, A_{i,*} is used to denote its i-th row and A_{*,j} to denote its j-th column. ∥A∥₀ is used to denote the [symbol] semi-norm of A that measures the number of nonzero entries in A.

Given a rank-k, m×n n real matrix A, k (A) is used to denote its condition number:

$$k ( A ) = \frac{{σ}_{1} ( A )}{{σ}_{k} ( A )}$$

where θ₁(A), . . . , σₖ(A) are singular values of A sorted in magnitude. When A is clear from context, K is often used directly.

For a n×n matrix A, it is positive semi-definite (PSD, A [symbol] 0) if for all x, [symbol] Ax≥0. It is positive definite (PD, A [symbol] 0) if for all x∈ [symbol] \ Oₙ, we have [symbol] Ax>0.
ASSUMPTIONS AND DEFINITIONS: In this section, a mathematical formulation of the multiple parallel fine-tuning tasks model is provided.
Definition 2.1 (A mathematical interpretation of the: model, restatement of Definition 1.1). Let L: [symbol] × [symbol] → [symbol] denote a loss function. Let k≥ 1 denote a positive integer. Define the global loss function [symbol] : [symbol] × [symbol] → [symbol] as follows

$$ℒ ( x , y ) : = {\sum }_{i = 1}^{k} L ( x , {y}_{i} )$$

Where y∈ [symbol] is a vector that concatenates all k parameters for each yᵢ:

$$y : = [ \begin{matrix}{y}_{1} \\ {y}_{2} \\ ⋮ \\ {y}_{k}\end{matrix} ]$$

The following highlights the connection between this formulation and the fine-tuning scheme described herein. The approach described herein would resemble that of LORA, with the significant difference that if there are k tasks, LoRA would maintain k pairs of matrices Aᵢ, Bᵢ, but the approach described herein would share a single A across all k tasks while only let each task vary their Bᵢ's. In the above formulation, one can view x as a shared parameter across all local losses and yᵢ's are the customized parameters that are unique to each task. It is also noted that the loss function can be varied by replacing L with Li and the results still hold. For the simplicity of presentation, the same loss is used across all tasks.

The gradient of the loss function can be compactly expressed in the following way:

### Claim 2.2.

$$\frac{d ℒ ( x , y )}{d ( x , y )} = [ \begin{matrix}{\sum }_{i = 1}^{k} \frac{d ℒ ( x , {y}_{i} )}{dx} \\ \frac{d ℒ ( x , {y}_{1} )}{{dy}_{1}} \\ ⋮ \\ \frac{d ℒ ( x , {y}_{k} )}{{dy}_{k}}\end{matrix} ]$$

Proof. The proof of this statement follows straightforward by using chain rule.

The form of the gradient enables performance of a “partial decomposition”: it can be decomposed into a term contributed by the shared term, and k terms correspond to individual parameters. This motivates to prove structural property of the global loss based on individual loss. Below shows several standard properties of loss functions, such as Lipschitzness, smoothness and (strong) convexity, can be readily propagated from individual loss to global loss.

### Lipschitz Property:

Definition 2.3. Function L: [symbol] × [symbol] → [symbol] is γ-Lipschitz if

$$\vert L ( x , {y}_{i} ) - L ( \tilde{x} , {\tilde{y}}_{ι} ) \vert \leq γ \cdot {\vert \vert \begin{matrix}x \\ {y}_{i}\end{matrix} - \begin{matrix}\tilde{x} \\ {\tilde{y}}_{ι}\end{matrix} \vert \vert}_{2}$$

Lemma 2.4 (Formal version of Lemma 1.2). If L: [symbol] × [symbol] → [symbol] is γ-Lipschitz, then [symbol] : [symbol] × [symbol] → [symbol] is (γk)-Lipschitz.
Proof. It can be shown:

$$\begin{matrix}{\vert ℒ ( x , y ) - ℒ ( \tilde{x} , \tilde{y} ) \vert}^{2} = {\vert {\sum }_{i = 1}^{k} ( L ( x , {y}_{i} ) - L ( \tilde{x} , {\tilde{y}}_{ι} ) ) \vert}^{2} \\ \leq k {\sum }_{i = 1}^{k} {\vert ( L ( x , {y}_{i} ) - L ( \tilde{x} , {\tilde{y}}_{ι} ) \vert}^{2} \\ \leq k {\sum }_{i = 1}^{k} {γ}^{2} {\vert \vert \begin{matrix}x \\ {y}_{i}\end{matrix} - \begin{matrix}\tilde{x} \\ {\tilde{y}}_{ι}\end{matrix} \vert \vert}_{2}^{2} \\ = k {γ}^{2} {\sum }_{i = 1}^{k} ( {\vert \vert x - \tilde{x} \vert \vert}_{2}^{2} + {\vert \vert {y}_{i} - {\tilde{y}}_{ι} \vert \vert}_{2}^{2} ) \\ \leq {k}^{2} {γ}^{2} ( {\vert \vert x - \tilde{x} \vert \vert}_{2}^{2} + {\sum }_{i = 1}^{k} {\vert \vert {y}_{i} - {\tilde{y}}_{ι} \vert \vert}_{2}^{2} ) \\ = {k}^{2} {γ}^{2} ( {\vert \vert x - \tilde{x} \vert \vert}_{2}^{2} + {\vert \vert y - \tilde{y} \vert \vert}_{2}^{2} ) \\ = {k}^{2} {γ}^{2} \cdot {\vert \vert \begin{matrix}x \\ y\end{matrix} - \begin{matrix}\tilde{x} \\ \tilde{y}\end{matrix} \vert \vert}_{2}^{2}\end{matrix}$$

where the first step follows from definition of [symbol] , the second step follows from Cauchy-Schwarz inequality, the third step follows from loss function L is γ-Lipschitz, the forth step follows definition of [symbol] norm, the fifth step follows from simple algebra, the sixth step follows from definition of [symbol] .

Taking the square root of both sides of the above equation:

$$\vert ℒ ( x , y ) - ℒ ( \tilde{x} , \tilde{y} ) \vert \leq k γ \cdot {\vert \vert \begin{matrix}x \\ y\end{matrix} - \begin{matrix}\tilde{x} \\ \tilde{y}\end{matrix} \vert \vert}_{2}$$

### Smoothness:

Definition 2.5. Function L: [symbol] × [symbol] → [symbol] is β-smooth if

$${\vert \vert ∇ L ( x , {y}_{i} ) - ∇ L ( \tilde{x} , {\tilde{y}}_{ι} ) \vert \vert}_{2} \leq β \cdot {\vert \vert [ \begin{matrix}x \\ {y}_{i}\end{matrix} ] - [ \begin{matrix}\tilde{x} \\ {\tilde{y}}_{ι}\end{matrix} ] \vert \vert}_{2}$$

Here ∇L (x, yᵢ) denote the gradient.
Lemma 2.6 (Formal version of Lemma 1.3). If function L is β-smooth, then [symbol] is (kβ)-smooth.

### Proof:

$$\begin{matrix}{\vert \vert ∇ ℒ ( x , y ) - ∇ ℒ ( \tilde{x} , \tilde{y} ) \vert \vert}_{2}^{2} = {\vert \vert {\sum }_{i = 1}^{k} ( ∇ L ( x , {y}_{i} ) - ∇ L ( \tilde{x} , {\tilde{y}}_{ι} ) ) \vert \vert}_{2}^{2} \\ \leq k {\sum }_{i}^{k} {\vert \vert ∇ ( L ( x , {y}_{i} ) - ∇ L ( \tilde{x} , {\tilde{y}}_{ι} ) \vert \vert}_{2}^{2} \\ \leq k {\sum }_{i = 1}^{k} {β}^{2} {\vert \vert [ \begin{matrix}x \\ {y}_{i}\end{matrix} ] - [ \begin{matrix}\tilde{x} \\ {\tilde{y}}_{ι}\end{matrix} ] \vert \vert}_{2}^{2} \\ = k {β}^{2} {\sum }_{i = 1}^{k} ( {\vert \vert x - \tilde{x} \vert \vert}_{2}^{2} + {\vert \vert {y}_{i} - {\tilde{y}}_{ι} \vert \vert}_{2}^{2} ) \\ \leq {k}^{2} {β}^{2} ( {\vert \vert x - \tilde{x} \vert \vert}_{2}^{2} + {\sum }_{i = 1}^{k} {\vert \vert {y}_{i} - {\tilde{y}}_{ι} \vert \vert}_{2}^{2} ) \\ = {k}^{2} {β}^{2} ( {\vert \vert x - \tilde{x} \vert \vert}_{2}^{2} + {\vert \vert y - \tilde{y} \vert \vert}_{2}^{2} ) \\ = {k}^{2} {β}^{2} \cdot {\vert \vert [ \begin{matrix}x \\ y\end{matrix} ] - [ \begin{matrix}\tilde{x} \\ \tilde{y}\end{matrix} ] \vert \vert}_{2}^{2}\end{matrix}$$

where the first step follows from definition of [symbol] , the second step follows from Cauchy-Schwarz inequality, the third step follows from loss function L is β-smooth, the forth step follows definition of [symbol] norm, the fifth step follows from simple algebra, the sixth step follows from definition of [symbol] .

Taking the square root of both sides of the above equation provides:

$${\vert \vert ∇ ℒ ( x , y ) - ∇ ℒ ( \tilde{x} , \tilde{y} ) \vert \vert}_{2} \leq k β \cdot {\vert \vert [ \begin{matrix}x \\ y\end{matrix} ] - [ \begin{matrix}\tilde{x} \\ \tilde{y}\end{matrix} ] \vert \vert}_{2}$$

### Convexity:

Definition 2.7. Function L: [symbol] × [symbol] → [symbol] is α-strongly convex if

$${∇}^{2} L ( ) ≽ α \cdot {I}_{d + m}$$

Without any assumption on do, a, k relationship, the hessian ∇² [symbol] (x, y) might not be psd due to certain counter-example (see Section A).
Lemma 2.8 (Formal version of Lemma 1.4). If the following conditions hold:

$$\begin{matrix} Let k \geq 1 denote a positive integer . \\ {∇}_{x}^{2} L ( ) ≼ {α}_{0} \cdot {I}_{d} , where {α}_{0} > 0. \\ L : {ℝ}^{d} \times {ℝ}^{m} \to ℝ is α - strongly convex , where α > 0. \\ Let ( k - 1 ) ( {α}_{0} - α ) \leq α / 2.\end{matrix}$$

then [symbol] [symbol] × [symbol] → [symbol] is α/2-strongly convex.
Proof. Note that

$${∇}^{2} ℒ ( x , y ) ∈ {ℝ}^{( d + k m ) \times ( d + k m )}$$

The Hessian matrix can be considered as (k+1)×(k+1) blocks.

For convenience, ∇² [symbol] (x, y) can be rewritten as follows

$${∇}^{2} ℒ ( x , y ) = [ \begin{matrix}{H}_{0 , 0} & {H}_{0 , 1} & … & {H}_{0 , k} \\ {H}_{1 , 0} & {H}_{1 , 1} & … & {H}_{1 , k} \\ ⋮ & ⋮ & ⋱ & ⋮ \\ {H}_{k , 0} & {H}_{k , 1} & … & {H}_{k , k}\end{matrix} ]$$

where H_{0,0}∈ [symbol] , H_{i,i}∈ [symbol] for all i∈[k], H_{0,i} ∈ [symbol] , H_{i,0}∈ [symbol] and H_{i,j}∈ [symbol] .

Since yᵢ and yⱼ has no correlation in loss function, thus H_{i,j} ∈O_{m×m} is an all zero matrix.

From assumption, it is known L is α-strongly convex, thus for all i∈[k], and

$$[ \begin{matrix}{H}_{0 , 0} & {H}_{0 , i} \\ {H}_{i , 0} & {H}_{i , j}\end{matrix} ] ≽ , α \cdot {I}_{m + d}$$

Picking up a vector ∈ [symbol] , let z₀∈ [symbol] , let zᵢ∈ [symbol] for all i∈[k]. Then:

$$\begin{matrix}{z}^{T} {∇}^{2} ℒ ( x , y ) z = {z}_{0}^{T} {H}_{0 , 0} {z}_{0} + {\sum }_{i = 1}^{k} {z}_{i}^{T} {H}_{i} , {z}_{i} + {\sum }_{i = 1}^{k} {z}_{i}^{T} {H}_{i , 0} {z}_{0} + {z}_{0}^{T} {H}_{0 , i} {z}_{i}^{T} \\ = k \cdot {z}_{0}^{T} {H}_{0 , 0} {z}_{0} + {\sum }_{i = 1}^{k} {z}_{i}^{T} {H}_{i , i} {z}_{i} + {\sum }_{i = 1}^{k} {z}_{i}^{T} {H}_{i , 0} {z}_{0} + {z}_{0}^{T} {H}_{0 , i} {z}_{i}^{T} - ( k - 1 ) \cdot {z}_{0} {H}_{0 , 0} {z}_{0} \\ = {\sum }_{i = 1}^{k} ( {z}_{0}^{T} {H}_{0 , 0} {z}_{0} + {z}_{i}^{T} {H}_{i , i} {z}_{i} + {z}_{i}^{T} {H}_{i , 0} {z}_{0} + {z}_{0}^{T} {H}_{0 , i} {z}_{i} ) - ( k - 1 ) \cdot {z}_{0}^{T} {H}_{0 , 0} {z}_{0} \\ \geq {\sum }_{i = 1}^{k} α ( {\vert \vert {z}_{0} \vert \vert}_{2}^{2} + {\vert \vert {z}_{i} \vert \vert}_{2}^{2} ) - ( k - 1 ) {z}_{0}^{T} {H}_{0 , 0} {z}_{0} \\ \geq {\sum }_{i = 1}^{k} α ( {\vert \vert {z}_{0} \vert \vert}_{2}^{2} + {\vert \vert {z}_{i} \vert \vert}_{2}^{2} ) - ( k - 1 ) {α}_{0} \vert {\vert {z}_{0} \vert}_{2}^{2} \vert \\ = α {\vert \vert z \vert \vert}_{2}^{2} - ( k - 1 ) \cdot ( {α}_{0} - α ) {\vert \vert {z}_{0} \vert \vert}_{2}^{2} \\ \geq α {\vert \vert z \vert \vert}_{2}^{2} - ( k - 1 ) \cdot ( {α}_{0} - α ) {\vert \vert z \vert \vert}_{2}^{2} \\ = α {\vert \vert z \vert \vert}_{2}^{2} - 0 \text{.5} α {\vert \vert z \vert \vert}_{2}^{2} \\ = 0.5 α {\vert \vert z \vert \vert}_{2}^{2}\end{matrix}$$

where the first follows from definition of Hessian, the second step follows from simple algebra, the third step follows from simple algebra, the forth step follows from L is α-strongly convex, the fifth step follows from

$${∇}_{x}^{2} L ( x , {y}_{i} ) ≼ {α}_{0} \cdot {I}_{d} ,$$

the sixth step follows from simple algebra, the seventh step follows from

$${\vert \vert {z}_{0} \vert \vert}_{2}^{2} \leq {\vert \vert z \vert \vert}_{2}^{2} ,$$

the eight step follows from assumption of do and a, the ninth step follows from simple algebra.

### Example Methods for Neural Network Model Adaptation and Inference Via Matrix Sharing

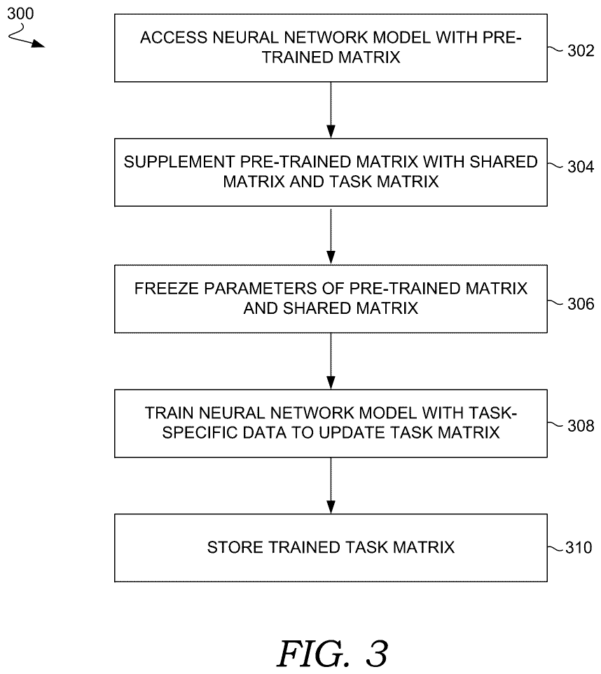

With reference now to FIG. 3, a flow diagram is provided that illustrates a method 300 for model adaptation in accordance with some aspects of the technology described herein. The method 300 can be performed, for instance, by the matrix supplementation component 110 and the task-specific model training component 112 of FIG. 1. Each block of the method 300 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, a neural network model is accessed that has at least one layer with a pre-trained matrix. The layer with the pre-trained matrix is supplemented with a shared matrix and a task matrix to provide a supplemented matrix, as shown at block 304. In some aspects, multiple layers are supplemented with a shared matrix and a task matrix to provide multiple supplemented layers. The parameters of the pre-trained matrix and the shared matrix at each supplemented layer are frozen as shown at block 306.

The supplemented neural network model is trained with task-specific training data (e.g., via backpropagation), as shown at block 308. For instance, training data for a particular task is accessed and used to train the supplemented neural network model by updating the task matrix at each supplemented layer to provide a trained task matrix at each supplemented layer. The trained task matrix for each supplemented layer is stored as matrix data in a data store, such as the data store 106 of FIG. 1. The process of training the supplemented neural network model at block 308 and storing of a trained task matrix for each supplemented layer at block 310 can be performed for each of a number of different tasks using task-specific training data for each task. The training for each task can be performed sequentially or in parallel.

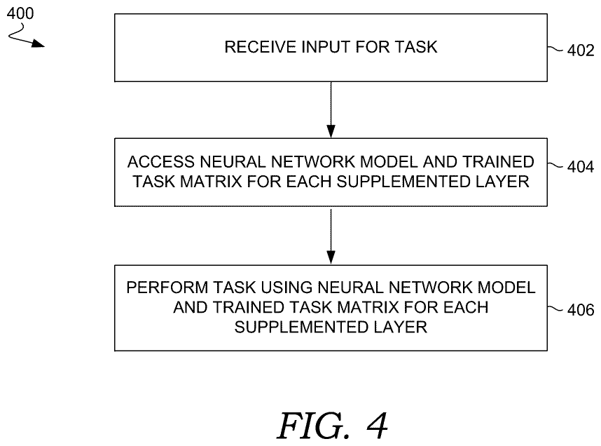

Turning next to FIG. 4, a flow diagram is provided showing a method 400 for model inference in accordance with aspects of the technology described herein. The method 400 can be performed, for instance, by the model inference component 114 of FIG. 1. As shown at block 402, input for a task is received. A neural network model and a trained task matrix for each supplemented layer of the neural network model are accessed at block 404. Each supplemented layer of the neural network model includes a pre-trained matrix and a shared matrix. The trained task matrix for each supplemented layer can be accessed, for instance, by determining a task type for the input, and retrieving, from a data store such as the data store 106 of FIG. 1, the trained task matrix for each supplemental layer for that task type. As shown at block 406, the task is performed by processing the input using the neural network model with each supplemented layer using a pre-trained weight matrix, a shared matrix, and a trained task matrix for the task type retrieved at block 404.

### Exemplary Operating Environment

Having described implementations of the present disclosure, an exemplary operating environment in which embodiments of the present technology can be implemented is described below in order to provide a general context for various aspects of the present disclosure. Referring initially to FIG. 5 in particular, an exemplary operating environment for implementing embodiments of the present technology is shown and designated generally as computing device 500. Computing device 500 is but one example of a suitable computing environment and is not intended to suggest any limitation as to the scope of use or functionality of the technology. Neither should the computing device 500 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 5, computing device 500 includes bus 510 that directly or indirectly couples the following devices: memory 512, one or more processors 514, one or more presentation components 516, input/output (I/O) ports 518, input/output components 520, and illustrative power supply 522. Bus 510 represents what can be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 5 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer storage media in the form of volatile and/or nonvolatile memory. The memory can be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which can be built in. Illustrative components include a microphone, joystick, game pad, satellite dish, scanner, printer, wireless device, etc. The I/O components 520 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 500. The computing device 500 can be equipped with depth cameras, such as, stereoscopic camera systems, infrared camera systems, RGB camera systems, and combinations of these for gesture detection and recognition. Additionally, the computing device 500 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing a neural network model with a pre-trained matrix at a layer of the neural network model;
adding a shared matrix and a task matrix to the pre-trained matrix at the layer of the neural network model; and
training the neural network model for a plurality of tasks by updating the task matrix for each task to provide a trained task matrix for each task while maintaining the pre-trained matrix and the shared matrix the same for all tasks.

2. The one or more computer storage media of claim 1, wherein the operations further comprise:
receiving an input for a first task from the plurality of tasks; and
performing the first task using the pre-trained matrix, the shared matrix, and the trained task matrix for the first task at the layer of the neural network model.

3. The one or more computer storage media of claim 2, wherein the operations further comprise:
determining the input corresponds to the first task; and
accessing the trained task matrix in response to determining the input corresponds to the first task.

4. The one or more computer storage media of claim 2, wherein the operations further comprise:
receiving an input for a second task from the plurality of tasks; and
performing the second task using the pre-trained matrix, the shared matrix, and the trained task matrix for the second task at the layer of the neural network model.

5. The one or more computer storage media of claim 4, wherein the second task is performed after performing the first task by:
subtracting the trained task matrix for the first task to obtain the pre-trained matrix and the shared matrix; and
adding the trained task matrix for the second task.

6. The one or more computer storage media of claim 1, wherein parameters of the shared matrix are initialized with random Gaussian values.

7. The one or more computer storage media of claim 1, wherein parameters of the task matrix are initialized with zero values.

8. The one or more computer storage media of claim 1, wherein the neural network model comprises a second pre-trained matrix at a second layer, and wherein the operations further comprise:
adding a second shared matrix and a second task matrix to the second pre-trained matrix at the second layer of the neural network model; and
wherein the neural network model is trained for the plurality of tasks by also updating the second task matrix for each task to provide a trained second task matrix for each task while maintaining the second pre-trained matrix and the second shared matrix for all tasks.

9. A computer-implemented method comprising:
receiving, at a model inference component, an input for a task;
determining, by the model inference component, a task type for the input;
retrieving, from a data store, a task matrix for a layer of a neural network model based on the task type, the layer of the neural network model including a pre-trained matrix and a shared matrix, the shared matrix being shared by one or more other tasks; and
performing the task for the input using the neural network model with the pre-trained matrix, the shared matrix, and the task matrix at the layer of the neural network model.

10. The computer-implemented method of claim 9, wherein the neural network model includes a second layer having a second pre-trained matrix and a second shared matrix, the second shared matrix being shared by the one or more other tasks, and wherein the method further comprises:
retrieving, from the data store, a second task matrix for the second layer of the neural network model based on the task type; and wherein the task is performed for the input using the second pre-trained matrix, the second shared matrix, and the second task matrix at the second layer of the neural network model.

11. The computer-implemented method of claim 9, wherein the method further comprises:
receiving a second input for a second task;
determining, by the model inference component, a second task type for the second input;
retrieving, from the data store, a second task matrix for the layer of the neural network model based on the second task type; and
performing the second task for the second input using the neural network model with the pre-trained matrix, the shared matrix, and the second task matrix at the layer of the neural network model.

12. The computer-implemented method of claim 11, wherein performing the second task for the second input comprises:
subtracting the task matrix to obtain the pre-trained matrix and shared matrix; and
adding the second task matrix.

13. A computer system comprising:
one or more processors; and
one or more computer storage media storing computer-useable instructions that, when used by the one or more processors, causes the computer system to perform operations comprising:
accessing a neural network model having a first-layer pre-trained matrix for a first layer of the neural network model;
supplementing, by a matrix supplementation component, the first-layer pre-trained matrix with a first-layer shared matrix and a first-layer task matrix to provide a supplemented neural network model;
freezing, by a task-specific model training component, parameters of the first-layer pre-trained matrix and parameters of the first-layer shared matrix; and
fine-tuning, by the task-specific model training component, the supplemented neural network model for a first task by updating parameters of the first-layer task matrix using a first set of training data to provide a trained first-layer first-task matrix.

14. The computer system of claim 13, wherein the operations further comprise:
receiving an input for the first task; and
performing the first task using the first-layer pre-trained matrix, the first-layer shared matrix, and the trained first-layer first-task matrix.

15. The computer system of claim 14, wherein the operations further comprise:
determining the input corresponds to the first task; and
accessing the trained first-layer first-task matrix in response to determining the input corresponds to the first task.

16. The computer system of claim 13, wherein the operations further comprise:
fine-tuning the supplemented neural network model for a second task by updating the first-layer task matrix using a second set of training data to provide a trained first-layer second-task matrix.

17. The computer system of claim 16, wherein the operations further comprise:
receiving an input for the second task; and
performing the second task using the first-layer pre-trained matrix, the first-layer shared matrix, and the trained first-layer second-task matrix.

18. The computer system of claim 17, wherein the second task is performed after performing the first task by:
subtracting the trained first-layer first-task matrix to obtain the first-layer pre-trained matrix and the first-layer shared matrix; and
adding the trained first-layer second-task matrix.

19. The computer system of claim 13, wherein the parameters of the first-layer shared matrix are initialized with random Gaussian values, and wherein the parameters of the first-layer task matrix are initialized with zero values.

20. The computer system of claim 13, wherein the neural network model comprises a second-layer pre-trained matrix for a second layer, and wherein the operations further comprise:
supplementing the second-layer pre-trained matrix with a second-layer shared matrix and a second-layer task matrix to provide the supplemented neural network model;
freezing parameters of the second-layer pre-trained matrix and the second-layer shared matrix; and
wherein the supplemented neural network model is fine-tuned for the first task by also updating parameters of the second-layer task matrix using the first set of training data to provide a trained second-layer first-task matrix.
